(19) United States
(12) Patent Application Publication
(10) Pub. No.: US 2025/0303906 A1
(43) Pub. Date: Oct. 2, 2025

(54) SYSTEMS AND METHODS FOR OPTIMIZING VEHICLE CHARGING AND DISCHARGING

(71) Applicant: Ford Global Technologies, LLC, Dearborn, MI (US)

(72) Inventors: Dominique Meroux, Ann Arbor, MI (US); Kai Wu, PITTSBURGH, PA (US); Ruoxi Wen, Indianapolis, IN (US); Hyongju Park, Ann Arbor, MI (US); Chen Zhang, South Lyon, MI (US)

(73) Assignee: Ford Global Technologies, LLC, Dearborn, MI (US)

(21) Appl. No.: 18/624,923

(22) Filed: Apr. 2, 2024

(51) Int. Cl. B60L 53/62; B60L 53/64; B60L 53/66; H02J 3/32

(52) U.S. Cl. CPC B60L 53/62; B60L 53/64; B60L 53/66; H02J 3/322; B60L 2260/52; B60L 2260/54; B60L 2260/58; B60L 2270/10

(57) ABSTRACT

A vehicle charging management system including a transceiver and a processor is disclosed. The transceiver may be configured to receive user itinerary information associated with a user, a current state of charge (SoC) level associated with a vehicle, and information associated with expected vehicle charging parameters at different times of a day. The processor may be configured to determine an optimal vehicle charging time duration and an optimal vehicle discharging time duration for the vehicle at a predefined location based on the user itinerary information, the current SoC level and the information associated with expected vehicle charging parameters. The processor may further transmit information associated with the optimal vehicle charging time duration and the optimal vehicle discharging time duration to the vehicle and/or a charging station device associated with a charging station located at the predefined location.

### FIELD

The present disclosure relates to systems and methods for optimizing vehicle charging and discharging at a charging station.

### BACKGROUND

Electric Vehicles (EVs) require regular charging at EV charging stations to ensure optimal vehicle operation. Many modern EVs include bi-directional charging feature, which enables the EVs to not only charge at the charging stations, but also transfer energy back to the grid when, e.g., the EVs may have excess stored energy.

Further, it is known that during peak hours, electric energy price and/or greenhouse gas emission rate associated with the energy required to charge an EV are high. If an EV is charged during such time durations, it may result in inconvenience to the EV owner, and may also affect the environment.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example graph of greenhouse gas emission rate with time in accordance with the present disclosure.

FIG. 3 depicts a flow diagram of an example first vehicle charging management method in accordance with the present disclosure.

FIG. 4 depicts a flow diagram of an example second vehicle charging management method in accordance with the present disclosure.

### DETAILED DESCRIPTION

### Overview

The present disclosure describes a vehicle charging management system (“system”) that may be configured to optimize charging and discharging time duration and/or power for one or more bi-directional electric vehicles (EVs). The system's objective is to enable improved mobility and sustainability outcomes by integrating modal shift with smart charging strategies. Smart charge parameters are adjusted on real-time estimated time of arrival information, for example, in the context of commuter park-and-ride with EV charging, involving coordination between a train and a last-mile vehicle for the trip to- and from work. The system may be hosted on a server or a distributed computing system and may be communicatively coupled with a plurality of vehicles, servers, charging station devices, and/or the like. For example, the system may be communicatively coupled with a first vehicle associated with a user, a second vehicle that may be an electric train or bus, a third vehicle that may be an E-transit van/bus, a charging station device associated with a charging station that may be located at a train/bus station (associated with the second device), and/or the like. The first vehicle may be a bi-directional EV, and the third vehicle may be similar to the first vehicle.

In some aspects, the user may be required to travel between a source location (e.g., user home) and a destination location (user office). In an exemplary aspect, to travel between the source location and the destination location, the user may travel from the source location to a first train station via the first vehicle, park the first vehicle at the first train station and plug the first vehicle to a charging station located at the first train station. The user may then travel from the first train station to a second train station via the second vehicle, and then finally travel from the second train station to the destination location via the third vehicle. The user may follow a similar pattern in reverse to travel back from the destination location to the source location.

In some aspects, the first vehicle may stay plugged in to the charging station while the user may be away from the first train station. The system may be configured to determine an optimal vehicle charging and discharging strategy for the first vehicle while the first vehicle may be plugged in to the charging station, such that the first vehicle may charge at the charging station in an economical manner, and the charging/discharging activities benefit the environment.

The system may be configured to obtain user itinerary information, information associated with an expected first vehicle future usage, first vehicle information (e.g., state of charge (SoC) level), and information associated with vehicle charging parameters at different times of a day. In some aspects, the vehicle charging parameters may include greenhouse gas emission rate per unit energy that may be required to charge a vehicle and/or per unit energy price. In some aspects, the greenhouse gas emission rate may be a marginal emissions rate, reflecting the marginal power source needed to support incremental power demand. Further, in some aspects, consideration of marginal energy emissions rate could be generalized to factor in a wide array of environmental effect categories.

The system may determine a target SoC level for the first vehicle based on the expected first vehicle future usage and/or user inputs/preferences. Responsive to determining the target SoC level, the system may determine the optimal vehicle charging and discharging strategy based on the target SoC level, the user itinerary information, and the information associated with vehicle charging parameters. The optimal vehicle charging and discharging strategy may ensure that the first vehicle charges at a time duration of the day when the greenhouse gas emission rate and/or the per unit energy price may be low and discharges at a time duration of the day when the greenhouse gas emission rate and/or the per unit energy price may be high.

Responsive to determining the optimal vehicle charging and discharging strategy, the system may transmit information associated with the optimal vehicle charging and discharging strategy to the charging station at the first train station and/or the first vehicle, to enable first vehicle charging/discharging based on the determined strategy. In this manner, the system may enable the first vehicle to charge to the target SoC level in an economical and environment-friendly manner.

The system may further track updates/changes to the user itinerary information, the vehicle charging parameters and/or energy demand at the first train station, and update the vehicle charging and discharging strategy for the first vehicle regularly based on the updated information.

The present disclosure discloses a vehicle charging management system that facilitates in optimally charging and discharging a bi-directional EV in an economical and environment-friendly manner. Specifically, the system enables the vehicle to charge when the greenhouse gas emission rate and/or the per unit energy price may be low and transfer energy to the grid and/or to another vehicle/equipment when the greenhouse gas emission rate and/or the per unit energy price may be high. The system further updates the vehicle charging and discharging strategy when a demand for instantaneous power (KW) and/or event-level total energy (kWh) to be charged at the train station may be greater than an expected energy demand, thereby enhancing convenience of a plurality of vehicle operators and helping the environment in cutting down greenhouse gas emission.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

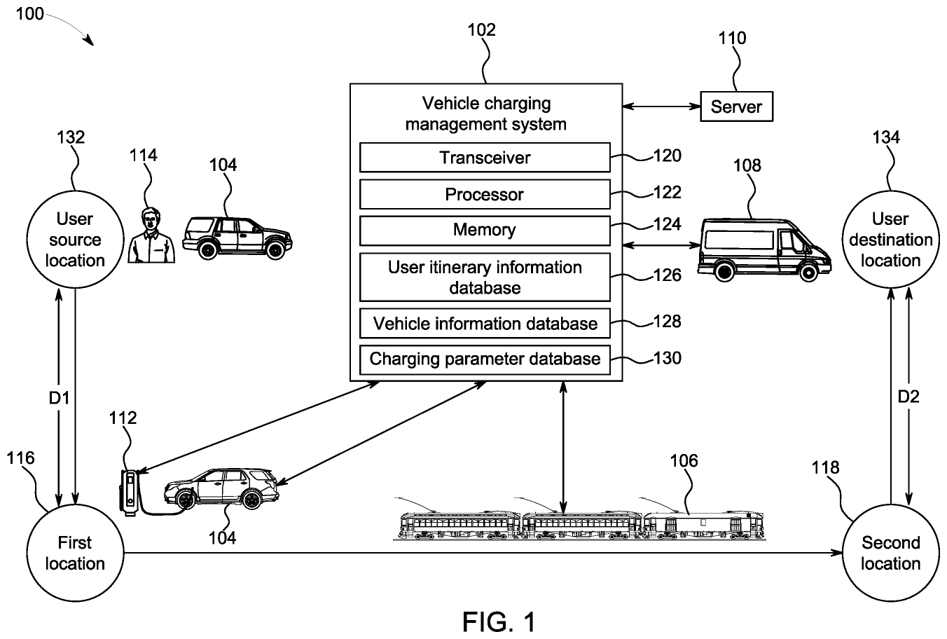

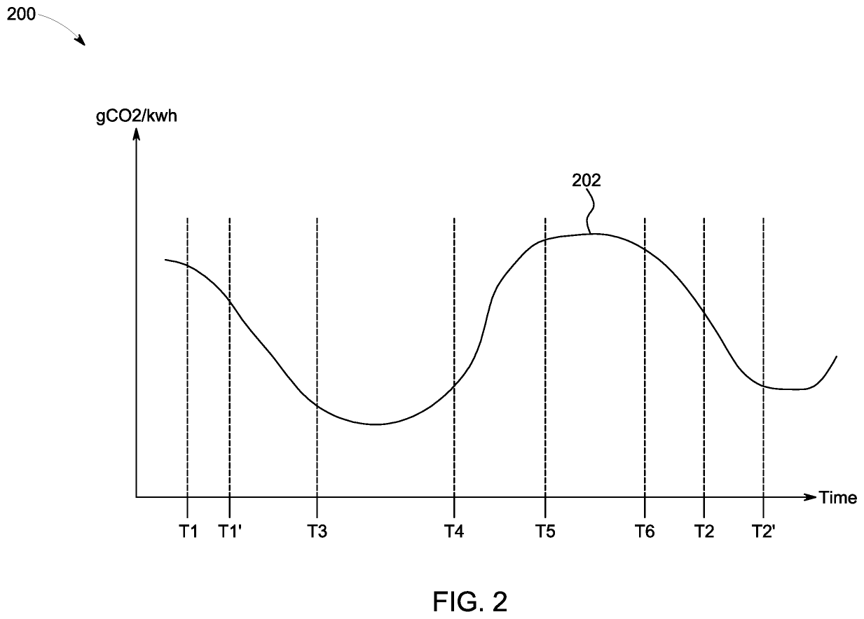

FIG. 1 depicts an example environment 100 in which techniques and structures for providing the systems and methods disclosed herein may be implemented. While describing FIG. 1, references will be made to FIG. 2.

The environment 100 may include a vehicle charging management system 102 (or system 102) that may be configured to optimize vehicle charging strategies of one or more bi-directional electric vehicles (EVs), such that the EVs may charge when an energy price and/or greenhouse gas emission rate associated with the energy required to charge the EVs may be low and may discharge when the energy price and/or the greenhouse gas emission rate may be high. The system 102 may be hosted on a server or a distributed computing system.

In some aspects, the system 102 may be communicatively coupled with a plurality of vehicles, computing systems, servers, chargers/charging stations, user devices, and/or the like via a wireless network (not shown). For example, as shown in FIG. 1, the system 102 may be communicatively coupled with a first vehicle 104, a second vehicle 106, a third vehicle 108, and/or the like. The system 102 may further be communicatively coupled with a server 110, a first charging station device (e.g., a computing device or a controller, not shown) associated with a first charger or first charging station 112, and/or the like.

The wireless network described above illustrates an example communication infrastructure in which the connected devices discussed in various embodiments of this disclosure may communicate. The wireless network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The first vehicle 104 may be associated with a user 114 and may be, for example, a “low-uptime” bi-directional Electric Vehicle (EV). In some aspects, a low-uptime vehicle, as described herein the present disclosure, may mean a vehicle that may be parked (or not be in use) for relatively longer time durations and may have predictable and/or scheduled travel times, parking times, and available or deducible future usage information. Examples of the first vehicle 104 may include, but are not limited to, a vanpool, a carpool, a carshare, a personal vehicle, and/or the like. Further, a bi-directional EV, as described herein the present disclosure, may mean a vehicle that may be configured to obtain electric energy from a charging station (e.g., the first charging station 112) during vehicle charging operation and also transfer energy from a vehicle energy storage (e.g., a vehicle battery, not shown) back to the charging station or to the grid/another vehicle/equipment during vehicle discharging operation. Stated another way, electric energy flows from the grid to the first vehicle 104 via the charging station during the vehicle charging operation, and electric energy flows from the first vehicle 104 (specifically from the vehicle's battery) to the grid or another vehicle/equipment during the vehicle discharging operation.

The third vehicle 108 may be similar to the first vehicle 104 and may be, for example, an E-transit van, an E-bike, scooter, and/or the like. The second vehicle 106, on the other hand, may be, for example, a “high-uptime” EV that may be configured to travel between two or more fixed geographical locations (e.g., a first location 116 and a second location 118). In some aspects, a high-uptime vehicle, as described herein the present disclosure, may mean a vehicle that may have relatively fixed or preplanned travel schedule and may have a relatively short window of time duration for vehicle charging events. Examples of the second vehicle 106 may include, but are not limited to, trains, buses (including bus rapid transit (BRT)), shuttles, ride-share/taxis, etc. In an exemplary aspect, when the second vehicle 106 is a train, the first location 116 may be a “first train station” and the second location 118 may be a “second train station”. As another example, when the second vehicle 106 is a bus, the first location 116 may be a “first bus station” and the second location 118 may be a “second bus station”. The description below is provided in the context of the second vehicle 106 being a train; however, the present disclosure is not limited to such an aspect.

The first charging station 112 may be located at the first location 116 and may enable charging of a plurality of vehicles, e.g., the first vehicle 104, the second vehicle 106, and/or the like. The first charging station 112 may be configured to obtain power/energy from a power grid (not shown) and transfer the energy to the charging vehicle(s). In some aspects, the second location 118 may also include one or more charging stations (e.g., a second charging station, not shown) that may enable charging of the third vehicle 108, the second vehicle 106, and/or the like.

The server 110 may be part of a cloud-based computing infrastructure and may be associated with and/or include a Telematics Service Delivery Network (SDN) that provides digital data services to the system 102 and/or to the first vehicle 104, the second vehicle 106, the third vehicle 108, the first charging station device associated with the first charging station 112, and/or the like. In some aspects, the system 102 may be part of the server 110. In other aspects, the system 102 may be different from the server 110 and may be communicatively coupled with the server 110 as described above.

In further aspects, the server 110 may be configured to store user itinerary information associated with the user 114 and provide the user itinerary information to the system 102 at a predefined frequency or when the system 102 transmits a request to the server 110 to obtain such information. In some aspects, the server 110 may receive the user itinerary information from the user 114 via a user device (not shown) or the first vehicle 104. In other aspects, the server 110 may itself determine the user itinerary information based on information associated with historical travel pattern of the user 114, which may be stored (and regularly updated) in the server 110. The details included in the user itinerary information are described later in the description below.

In additional aspects, the server 110 may be associated with or communicatively coupled with a utility power/energy supply and may configured to store real-time and expected vehicle charging parameters at different times of a day, week, etc. In an exemplary aspect, the expected vehicle charging parameters may include an expected greenhouse gas emission rate per unit energy that may be used to charge a vehicle (e.g., the first vehicle 104) and/or an expected per unit energy price at a particular time of day. Similarly, the real-time vehicle charging parameters may include a real-time greenhouse gas emission rate per unit energy and/or a real-time per unit energy price at a particular time of day. An example graph 200 depicting greenhouse gas emission rate per unit energy (shown as a line plot 202) at different times of a day is shown in FIG. 2. The X-axis of the graph 200 depicts time (e.g., in hours) and the Y-axis depicts grams of Carbon Dioxide (CO2) that may be emitted to produce one kWh of energy (that may be used to charge a vehicle). The shape of the line plot 202 depicted in FIG. 2 is illustrated just as an example, and should not be construed as limiting. The line plot 202 may have any other shape, without departing from the present disclosure scope.

In some aspects, the server 110 may itself deduce/predict the expected vehicle charging parameters at different times of a day based on historical data associated with the greenhouse gas emission rate and per unit energy price that may be stored (and regularly updated) in the server 110. The server 110 may transmit the expected vehicle charging parameters and/or the real-time vehicle charging parameters to the system 102 at a predefined frequency or when the system 102 transmits a request to the server 110 to receive such information.

In additional aspects, the server 110 may be configured to store information associated with expected vehicle future usage associated with a plurality of vehicles (e.g., information associated with expected first vehicle future usage). The server 110 may receive the information associated with the expected first vehicle future usage from the user 114 via the user device or the first vehicle 104, or may itself deduce/determine the information based on the historical travel pattern of the user 114. The server 110 may transmit the information associated with the expected first vehicle future usage to the system 102 at a predefined frequency, or when the system 102 transmits a request to the server 110 to obtain such information.

The system 102, regardless of whether it is part of the server 110 or a separate system, may include a plurality of units including, but not limited to, a transceiver 120, a processor 122 and a memory 124, which may be communicatively coupled with each other. The transceiver 120 may be configured to transmit/receive information/data to/from external systems and devices via the wireless network described above. For example, the transceiver 120 may be configured to receive/transmit inputs/information/data from/to the first vehicle 104, the second vehicle 106, the third vehicle 108, the server 110, the first charging station device associated with the first charging station 112, the user device associated with the user 114, and/or the like.

The processor 122 may be in communication with one or more memory devices in communication with the respective computing systems (e.g., the memory 124 and/or one or more external databases not shown in FIG. 2). The processor 122 may utilize the memory 124 to store programs in code and/or to store data for performing aspects in accordance with the disclosure. The memory 124 may be a non-transitory computer-readable storage medium or memory storing a program code that enables the processor 122 to perform operations in accordance with the present disclosure. The memory 124 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 124 may include a plurality of databases including, but not limited to, a user itinerary information database 126, a vehicle information database 128, a charging parameter database 130, and/or the like. The itinerary information database 126 may store the user itinerary information associated with the user 114 (and plurality of other users, not shown) that the system 102 may receive from the user device associated with the user 114, the first vehicle 104 and/or the server 110. The vehicle information database 128 may store vehicle information associated with the first vehicle 104, which the system 102 may obtain from the first vehicle 104 and/or the server 110. In some aspects, the vehicle information may include, but is not limited to, information associated with state of charge (SoC) of the first vehicle 104, the expected first vehicle future usage, and/or the like. The charging parameter database 130 may store expected and real-time vehicle charging parameters that the system 102 may obtain from the server 110.

In operation, the transceiver 120 may receive a trigger signal from the first vehicle 104 when a vehicle ignition associated with the first vehicle 104 may be switched ON by the user 114. In some aspects, the user 114 may switch ON the vehicle ignition when the first vehicle 104 may be located at a user source location 132 (which may be, for example, user home) and when the user 114 desires to travel to a user destination location 134 (which may be, for example, user office). To comfortably and economically reach to the user destination location 134 in an environment-friendly manner, the user 114 may travel from the user source location 132 to the first location 116 via the first vehicle 104, then park the first vehicle 104 at the first location 116 (and plug the first vehicle 104 to the first charging station 112), and then travel from the first location 116 to the second location 118 via the second vehicle 106. The user 114 may then travel from the second location 118 to the user destination location 134 via the third vehicle 108. The user 114 may follow the reverse pattern to return to the user source location 132 from the user destination location 134.

Responsive to receiving the trigger signal from the first vehicle 104, the transceiver 120 may transmit the trigger signal to the processor 122. The processor 122 may then transmit, via the transceiver 120, requests to the first vehicle 104, the server 110, the user device associated with the user 114, and/or the like, to obtain the user itinerary information associated with the user 114, the vehicle information associated with the first vehicle 104, the expected (and real-time) vehicle charging parameters, information associated with the expected first vehicle future usage, etc.

Responsive to transmitting the requests described above, the transceiver 120 may receive the user itinerary information associated with the user 114, the vehicle information associated with first vehicle 104 including a current SoC level of the first vehicle 104 and the information associated with the expected first vehicle future usage, and the information associated with expected vehicle charging parameters at different times of the day. In some aspects, the transceiver 120 may receive the current SoC level from the first vehicle 104, the information associated with the expected first vehicle future usage from the server 110, and the user device associated with the user 114 and/or the first vehicle 104. Further, the transceiver 120 may receive the information associated with expected vehicle charging parameters at different times of the day from the server 110. As described above, the expected vehicle charging parameters may include the expected greenhouse gas emission rate and/or the expected per unit energy price.

In some aspects, the transceiver 120 may receive the user itinerary information associated with the user 114 from the user device associated with the user 114, the first vehicle 104 and/or the server 110. In an exemplary aspect, the user itinerary information may include one or more of an estimated time of user arrival (shown as time “T1” in FIG. 2, which may be, e.g., 8:30 AM) at the first location 116 from the user source location 132 via the first vehicle 104, a distance “D1” between the user source location 132 and the first location 116, an estimated time of user departure from the first location 116 to the second location 118 via the second vehicle 106 (that may be located/stationed at the first location 116), an estimate time of user arrival at the second location 118 via the second vehicle 106, a distance “D2” between the second location 118 and the user destination location 134, an estimated time of user return to the second location 118 from the user destination location 134 to travel to the first location 116 via the second vehicle 106, an estimated time of user arrival (shown as time “T2” in FIG. 2, which may be, e.g., 5:00 PM) at the first location 116 from the second location 118 via the second vehicle 106, and/or the like.

Responsive to receiving the information described above, the transceiver 120 may transmit the received information to respective memory databases for storage purpose and to the processor 122. The processor 122 may use the obtained information to determine an optimal vehicle charging and discharging strategy for the first vehicle 104, when the first vehicle 104 may be parked at the first location 116 and plugged to the first charging station 112 between the times “T1” and “T2”. In some aspects, the optimal vehicle charging and discharging strategy may include an optimal vehicle charging time duration, an optimal vehicle charging power, an optimal vehicle discharging time duration, and an optimal vehicle discharging power. The first vehicle 104 may be configured to obtain energy or charge at the first charging station 112 at the optimal vehicle charging time duration and configured to transfer energy from the vehicle energy storage (e.g., the vehicle's battery) to the grid via the first charging station 112 or to another vehicle (e.g., the second vehicle 106, or any other vehicle located at the first location 116) at the optimal vehicle discharging time duration.

In some aspects, to determine the optimal vehicle charging and discharging strategy for the first vehicle 104, the processor 122 may first estimate an SoC level (e.g., a “first SoC level”) associated with the first vehicle 104 at the estimated time of user arrival “T1” at the first location 116 via the first vehicle 104, based on the user itinerary information and the current SoC level of the first vehicle 104 at the user source location 132. Specifically, the processor 122 may estimate the first SoC level that the first vehicle 104 may have when the first vehicle 104 reaches the first location 116 from the user source location 132 based on the current SoC level of the first vehicle 104 at the user source location 132 and the distance “D1”. The processor 122 may further use information associated with historical driving pattern for the first vehicle 102/user 114 (that may be stored in the memory 124 or obtained from the server 110) to estimate the first SoC level.

The processor 122 may further determine a target SoC level associated with the first vehicle 104 at the estimated time of user arrival (i.e., the time “T2”) at the first location 116 from the second location 118 via the second vehicle 106. The target SoC level may be that SoC level that the user 114 may desire the first vehicle 104 to have, when the user 114 returns to the first location 116 from the second location 118 and unplugs the first vehicle 104 from the first charging station 112 (e.g., to travel back to the user source location 132 or to any other location). In some aspects, the processor 122 may determine the target SoC level based on the information associated with the expected first vehicle future usage. In additional or alternative aspects, the processor 122 may determine the target SoC level based on user inputs that the processor 122/transceiver 120 may obtain from the user 114 via the user device associated with the user 114 or the first vehicle 104 (e.g., via a first vehicle Human-Machine Interface (HMI), not shown).

Responsive to estimating the first SoC level and determining the target SoC level, the processor 122 may determine the optimal vehicle charging and discharging strategy based on the first SoC level, the target SoC level, the user itinerary information and the information associated with expected vehicle charging parameters. Specifically, the processor 122 may determine the optimal vehicle charging time duration and/or power and optimal vehicle discharging time duration and/or power for the time duration that the first vehicle 104 may be plugged to the first charging station 112 based on the first SoC level, the target SoC level, the times “T1” and “T2”, and specific time durations between the times “T1” and “T2” when the expected greenhouse gas emission rate and/or the expected per unit energy price may be high or low. In some aspects, the processor 122 may determine the optimal vehicle charging and discharging time duration/power such that when the user 114 returns to the first location 116 from the second location 118, the first vehicle 104 may have the target SoC level (or an SoC level slightly higher than the target SoC level, to add some buffer SoC to the first vehicle 104) and at the same time ensures that the first vehicle 104 charges at an optimal manner that may be economically beneficial to the user 114 and may have positive effect on the environment.

As an example, when the first vehicle 104 may be continuously plugged in to the first charging station 112 between the times “T1” and “T2” (when the user 114 may be away), the processor 122 may determine the optimal vehicle charging time duration as the time duration between times “T3” and “T4” when the expected greenhouse gas emission rate (and/or the expected per unit energy price) may be low, as shown in FIG. 2. During the time duration between the times “T3” and “T4”, the first vehicle 104 may get charged (or may obtain energy) from the first charging station 112/grid, as the expected greenhouse gas emission rate (and/or the expected per unit energy price) may be low, thereby providing economic benefits to the user 114 and helping the environment by causing less emission of greenhouse gases required to charge the first vehicle 104.

In a similar manner, the processor 122 may determine the optimal vehicle discharging time duration as the time duration between times “T5” and “T6” when the expected greenhouse gas emission rate (and/or the expected per unit energy price) may be high, as shown in FIG. 2. During the time duration between the times “T5” and “T6”, the first vehicle 104 may transfer energy stored in the vehicle battery to the grid via the first charging station 112 or may transfer energy to another vehicle that may be located at the first location 116 and may require charging.

In some aspects, the processor 122 may determine the times “T3” and “T4” (and the corresponding power at which the first vehicle 104 may get charged during the time duration between the times “T3” and “T4”) and the times “T5” and “T6” (and the corresponding power at which the first vehicle 104 may get discharged during the time duration between the times “T5” and “T6”) such that the first vehicle 104 economically charges at the first charging station 112, optimally provides energy back to the grid/other vehicles, have the least effect on the environment, and at the same time reaches to the target SoC level when the user 114 arrives back at the first location 116 at the time “T2” (from the second location 118). A person ordinarily skilled in the art may appreciate that the first vehicle 104 helps in reducing greenhouse gas emission by discharging or providing energy back to the grid during the time duration between the times “T5” and “T6” (i.e., when the expected greenhouse gas emission rate may be high).

Responsive to determining the optimal vehicle charging time duration (and/or power) and the optimal vehicle discharging time duration (and/or power), the processor 122 may transmit, via the transceiver 120, information associated with the optimal vehicle charging time duration (and/or power) and the optimal vehicle discharging time duration (and/or power) to the first vehicle 104 and/or the first charging station device associated with the first charging station 112. In some aspects, the processor 122 may transmit the information described above to the first vehicle 104 and/or the first charging station device when the user 114 commences the travel from the user source location 132 to the first location 116 via the first vehicle 104 and/or when the user 114 transmits a request (via the user device or the first vehicle 104) to the system 102 or the first charging station device to reserve a charger at the first charging station 112 for the first vehicle 104 at the time “T1”.

When the user 114 reaches the first location 116 from the user source location 132 and plugs-in the first vehicle 104 to the first charging station 112 (e.g., to the reserved charger), the first vehicle 104 and/or the first charging station 112 may use the information obtained from the processor 122 described above to automatically initiate the vehicle charging operation at the optimal vehicle charging time duration and the vehicle discharging operation at the optimal vehicle discharging time duration. In some aspects, the first vehicle 104 may stay plugged-in to the first charging station 112 at time durations others than the optimal vehicle charging and discharging time durations, but the first vehicle 104 may not get charged or discharged during such time durations.

In this manner, the processor 122/system 102 may enable the first vehicle 104 to automatically charge and discharge at optimal time durations when the first vehicle 104 may be plugged-in to the first charging station 112 between the times “T1” and “T2”.

The system 102 may be further configured to track real-time updates associated with user travel, vehicle charging parameters, energy demand at the first charging station 112, and/or the like, to update the determined optimal vehicle charging and discharging strategy described above. For example, when the user 114 reaches the first location 116 from the user source location 132 and plugs-in the first vehicle 104 to the first charging station 112, the processor 122 may determine an actual time of user arrival at the first location 116 and compare the actual time with the estimated time “T1”. The processor 122 may update the vehicle charging and discharging strategy if the actual time of user arrival may be different from the estimated time “T1”. For example, as shown in FIG. 2, if the actual time of user arrival is “T1′”, the processor 122 may update the estimated vehicle charging time duration (and/or power) and the estimated vehicle discharging time duration (and/or power) based on the actual time “T1′”.

In a similar manner, when the user 114 boards the third vehicle 108 from the user destination location 134 to travel to the second location 118 and/or when the user 114 boards the second vehicle 106 from the second location 118 to travel to the first location 116, the processor 122 may track third vehicle movement and second vehicle movement to determine an actual time of user arrival at the first location 116 from the second location 118 via the second vehicle 106. The processor 122 may further compare the actual time of user arrival at the first location 116 from the second location 118 with the estimated time “T2”. Responsive to determining that the actual arrival time (e.g., time “T2” shown in FIG. 2) may be different from the estimated time “T2” (e.g., due to train delay, third vehicle travel delay, etc.), the processor 122 may determine an updated vehicle charging time duration (and/or power) and an updated vehicle discharging time duration (and/or power) based on the actual time “T2”.

Responsive to determining the updated vehicle charging time duration (and/or power) and the updated vehicle discharging time duration (and/or power) as described in the examples above, the processor 122 may transmit, via the transceiver 120, information associated with the updated vehicle charging time duration (and/or power) and the updated vehicle discharging time duration (and/or power) to the first charging station device and/or the first vehicle 104. The first charging station device and/or the first vehicle 104 may then accordingly charge/discharge the first vehicle 104 via the first charging station 112 based on the updated vehicle charging time duration (and/or power) and the updated vehicle discharging time duration (and/or power). For example, when the estimated time “T2” may be delayed to the time “T2′”, the first vehicle 104 may get charged or discharged for more time duration (but still reach to the target SoC level), based on the estimated greenhouse gas emission rate and/or the per unit energy price. On the other hand, if the user 114 may be arriving earlier than the estimated time “T2” at the first location 116 from the second location 118, the first vehicle 104 may get charged quickly to the target SoC level or may discharge for a relatively shorter time duration.

As another example, the processor 122 may track real-time vehicle charging parameters and may update the vehicle charging and discharging strategy for the first vehicle 104 based on the real-time vehicle charging parameters. For example, responsive to determining that the user 114 may have connected/plugged-in the first vehicle 104 to the first charging station 112 at the estimated time “T1” or the actual time “T1′”, the processor 122 may commence to track/determine the real-time vehicle charging parameters. When the processor 122 determines that the real-time vehicle charging parameters may be different than the estimated vehicle charging parameters, the processor 122 may determine an updated vehicle charging and discharging strategy based on the real-time vehicle charging parameters. Stated another way, the processor 122 may determine an updated optimal vehicle charging time duration (and/or power) and an updated optimal vehicle discharging time duration (and/or power) based on the real-time vehicle charging parameters, when the real-time greenhouse gas emission rate and/or the real-time per unit energy price may be different from the corresponding estimated values. The processor 122 may then transmit, via the transceiver 120, the information associated with the updated vehicle charging time duration (and/or power) and the updated vehicle discharging time duration (and/or power) to the first charging station device and/or the first vehicle 104, as described above.

As yet another example, the processor 122 may track real-time energy demand at the first charging station 112 between the time “T1” (or the time “T1′”) and the time “T2” (or the time “T2′”) and may update the vehicle charging and discharging strategy for the first vehicle 104 based on the real-time energy demand. For example, responsive to determining that the user 114 may have connected/plugged-in the first vehicle 104 to the first charging station 112 at the estimated time “T1” or the actual time “T1′”, the processor 122 may commence to track/determine the energy demand at the first charging station 112. When the processor 122 determines that the real-time energy demand may be greater than an estimated energy demand (information of which may be pre-stored in the memory 124 or obtained from the server 110) at the first charging station 112 at any time of the day, the processor 122 may determine an updated optimal vehicle charging time duration (and/or power) and an updated optimal vehicle discharging time duration (and/or power) based on the real-time energy demand. For example, the processor 122 may update the vehicle charging and discharging strategy when a large count of vehicles (e.g., more than an expected count of vehicles) may require charging at the first charging station 112 between the times “T1” and “T2”, or when the second vehicle 106 may require additional energy to charge (e.g., more than an expected amount of energy) at the first charging station 112. Responsive to updating the vehicle charging and discharging strategy for the first vehicle 104, the processor 122 may transmit, via the transceiver 120, the information associated with the updated vehicle charging time duration (and/or power) and the updated vehicle discharging time duration (and/or power) to the first charging station device and/or the first vehicle 104, as described above.

In this manner, the processor 122/system 102 ensures that the first vehicle 104 optimally charges and/or discharges at the first charging station 112, even when there may be changes/updates in the user travel timings, vehicle charging parameters, energy demand at the first charging station 112, and/or the like.

The processor 122 may be further configured to calculate incentive points that may be offered to the user 114 to encourage the user 114 to park the first vehicle 104 at the first location 116 and use the second vehicle 106 more often for travel (as opposed to traveling from the user source location 132 to the user destination location 134 by using only the first vehicle 104). In some aspects, the processor 122 may calculate the incentive points for the user 114 based on the optimal (or updated) vehicle charging time duration, the optimal (or updated) vehicle discharging time duration, an amount of energy that the first vehicle 104 may have obtained from the first charging station 112 during the vehicle charging operation, and an amount of energy that the first vehicle 104 may have transferred to the grid or other vehicles during the vehicle discharging operation. The processor 122 may further transmit, via the transceiver 120, information associated with the calculated incentive points to the user device associated with the user 114 and/or the first vehicle 104. Responsive to receiving the information, the user 114 may redeem the incentive points for getting discounts on the energy price at the first charging station 112, discounts at one or more restaurants/shops located in proximity to the first and/or second locations 116, 118, discounts in second vehicle fare, and/or the like.

Although the description above describes an aspect where the first vehicle 104, the second vehicle 106 and the third vehicle 108 are EVs, in alternative aspects, these vehicles may use hydrogen as fuel for propulsion. Furthermore, the description above describes an aspect where the first vehicle 104 discharges at the first charging station 112 and provides energy to the grid and/or to other vehicles/equipment. In additional aspects, the third vehicle 108 may also discharge energy at the second location 118 and/or the user destination location 134 and provide energy to the grid and/or to other vehicles/equipment.

In alternative aspects, the first and second locations 116, 118 may be airports and not train stations as described above. In this case, the second vehicle 106 may be an airplane.

The first, second and third vehicles 104, 106, 108 and the system 102 implement and/or perform operations, as described here in the present disclosure, in accordance with the owner manual and safety guidelines. In addition, any action taken by the operators associated with the first, second and third vehicles 104, 106, 108 based on the notifications/recommendations provided by the system 102 should comply with all the rules specific to the location and operation of the first, second and third vehicles 104, 106, 108 (e.g., Federal, state, country, city, etc.). The notifications/recommendations, as provided by the system 102, should be treated as suggestions and only followed according to any rules specific to the location and operation of the first, second and third vehicles 104, 106, 108.

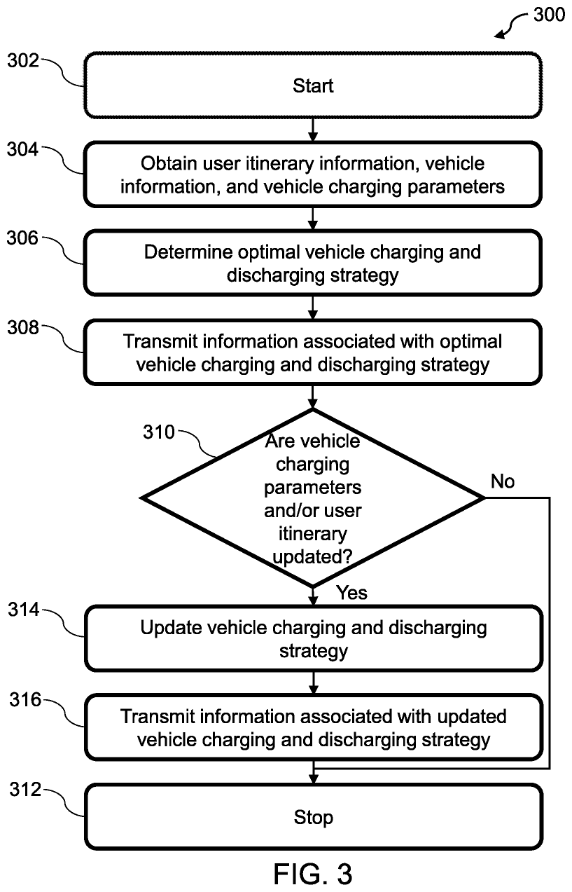

FIG. 3 depicts a flow diagram of an example first vehicle charging management method 300 in accordance with the present disclosure. FIG. 3 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 300 starts at step 302. At step 304, the method 300 may include obtaining, by the processor 122, the user itinerary information, the vehicle information and the information associated with the vehicle charging parameters. At step 306, the method 300 may include determining, by the processor 122, the optimal vehicle charging and discharging strategy based on the obtained information, as described above.

At step 308, the method 300 may include transmitting, by the processor 122, the information associated with the optimal vehicle charging and discharging strategy to the first charging station device and/or the first vehicle 104. At step 310, the method 300 may include determining, by the processor 122, whether the vehicle charging parameters and/or the user itinerary information may have been updated.

Responsive to determining that that there is no change in the vehicle charging parameters and/or the user itinerary information, the method 300 may move to step 312, at which the method 300 may stop. On the other hand, responsive to determining that the vehicle charging parameters and/or the user itinerary information may have changed, the processor 122 may update the vehicle charging and discharging strategy based on the updated information at step 314.

At step 316, the method 300 may include transmitting, by the processor 122, the information associated with the updated vehicle charging and discharging strategy to the first charging station device and/or the first vehicle 104. At the step 312, the method 300 may stop.

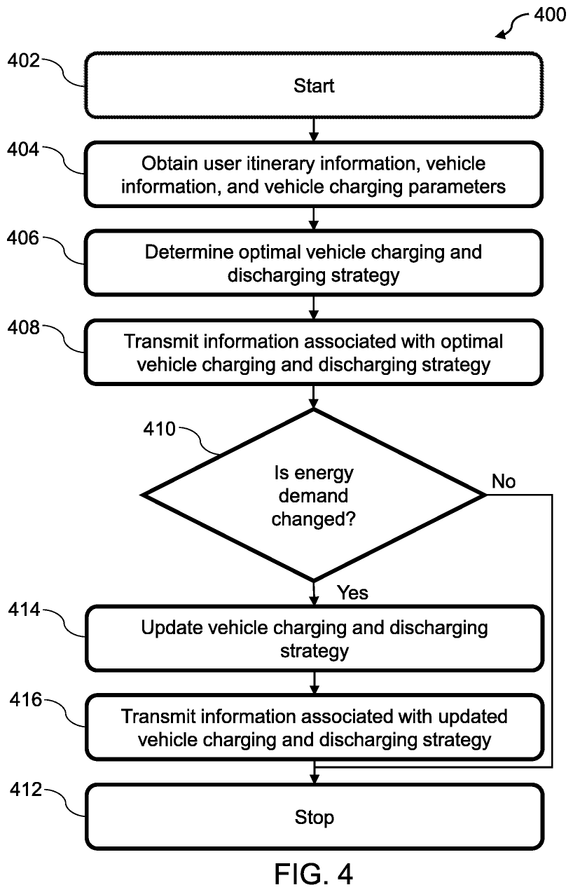

FIG. 4 depicts a flow diagram of an example second vehicle charging management method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. Steps 404, 406 and 408 may be same as the steps 304, 306 and 308 described above in conjunction with FIG. 3, and hence are not described again here for the sake of simplicity and conciseness.

At step 410, the method 400 may include determining, by the processor 122, whether the energy demand at the first location 116/first charging station 112 may have changed (relative to the estimated energy demand). Responsive to determining that that there is no change in the energy demand, the method 400 may move to step 412, at which the method 400 may stop. On the other hand, responsive to determining that the energy demand may have changed, the processor 122 may perform steps 414 and 416, which may be same as the steps 314 and 316 described above in conjunction with FIG. 3.

The method 400 may stop at the step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle charging management system comprising:
a transceiver configured to receive:
user itinerary information associated with a user and a current state of charge (SoC) level associated with a first vehicle, wherein the user itinerary information comprises an estimated time of user arrival at a first location from a user source location via the first vehicle; and
information associated with expected vehicle charging parameters at different times of a day; and
a processor communicatively coupled with the transceiver, wherein the processor is configured to:
determine an optimal vehicle charging time duration and an optimal vehicle discharging time duration for the first vehicle at the first location based on the user itinerary information, the current SoC level and the information associated with expected vehicle charging parameters; and
transmit information associated with the optimal vehicle charging time duration and the optimal vehicle discharging time duration to least one of the first vehicle or a first charging station device associated with a first charging station located at the first location.

2. The vehicle charging management system of claim 1, wherein the expected vehicle charging parameters comprise at least one of an expected greenhouse gas emission rate and an expected per unit energy price.

3. The vehicle charging management system of claim 1, wherein the user itinerary information further comprises at least one of:
a distance between the user source location and the first location,
an estimated time of user departure from the first location to a second location via a second vehicle located at the first location,
an estimate time of user arrival at the second location via the second vehicle,
a distance between the second location and a user destination location,
an estimated time of user return to the second location from the user destination location, to travel to the first location via the second vehicle, and
an estimated time of user arrival at the first location from the second location via the second vehicle.

4. The vehicle charging management system of claim 3, wherein the processor is further configured to:
estimate a first SoC level associated with the first vehicle at the estimated time of user arrival at the first location via the first vehicle, based on the user itinerary information;
determine a target SoC level associated with the first vehicle at the estimated time of user arrival at the first location from the second location via the second vehicle; and
determine the optimal vehicle charging time duration and the optimal vehicle discharging time duration based on the first SoC level and the target SoC level.

5. The vehicle charging management system of claim 4, wherein the transceiver is further configured to receive information associated with an expected first vehicle future usage, and wherein the processor determines the target SoC level based on the information associated with the expected first vehicle future usage.

6. The vehicle charging management system of claim 4, wherein the transceiver is further configured to receive user inputs, and wherein the processor determines the target SoC level based on the user inputs.

7. The vehicle charging management system of claim 3, wherein the first vehicle is a bi-directional Electric Vehicle (EV), wherein the first vehicle is configured to charge at the first charging station at the optimal vehicle charging time duration, and wherein the first vehicle is configured to transfer energy to a grid or the second vehicle at the optimal vehicle discharging time duration.

8. The vehicle charging management system of claim 3, wherein the processor is further configured to:
determine an actual time of user arrival at the first location from the second location via the second vehicle, when the user travels from the second location to the first location via the second vehicle;
determine that the actual time of user arrival at the first location from the second location is different than the estimated time of user arrival at the first location from the second location;
determine an updated optimal vehicle charging time duration and an updated optimal vehicle discharging time duration based on the actual time of user arrival at the first location from the second location, responsive to determining that the actual time of user arrival at the first location from the second location is different than the estimated time of user arrival at the first location from the second location; and
transmit information associated with the updated optimal vehicle charging time duration and the updated optimal vehicle discharging time duration to least one of the first charging station device or the first vehicle.

9. The vehicle charging management system of claim 3, wherein the second vehicle is a train or a bus.

10. The vehicle charging management system of claim 1, wherein the transceiver receives the user itinerary information from at least one of a user device, the first vehicle or a server, and wherein the transceiver receives the current SoC level from the first vehicle.

11. The vehicle charging management system of claim 1, wherein the processor is further configured to:
determine that the first vehicle is connected to the first charging station;
determine real-time vehicle charging parameters responsive to determining that the first vehicle is connected to the first charging station;
determine that the real-time vehicle charging parameters are different from the expected vehicle charging parameters;
determine an updated optimal vehicle charging time duration and an updated optimal vehicle discharging time duration based on the real-time vehicle charging parameters, responsive to determining that the real-time vehicle charging parameters are different from the expected vehicle charging parameters; and
transmit information associated with the updated optimal vehicle charging time duration and the updated optimal vehicle discharging time duration to least one of the first charging station device or the first vehicle.

12. The vehicle charging management system of claim 1, wherein the processor is further configured to:
determine that the first vehicle is connected to the first charging station;
determine that a real-time energy demand at the first charging station is greater than an expected energy demand at the first charging station, responsive to determining that the first vehicle is connected to the first charging station;
determine an updated optimal vehicle charging time duration and an updated optimal vehicle discharging time duration based on the real-time energy demand, responsive to determining that the real-time energy demand is greater than the expected energy demand; and
transmit information associated with the updated optimal vehicle charging time duration and the updated optimal vehicle discharging time duration to least one of the first charging station device or the first vehicle.

13. The vehicle charging management system of claim 1, wherein the processor is further configured to:
calculate incentive points for the user based on the optimal vehicle charging time duration and the optimal vehicle discharging time duration; and
transmit information associated with the incentive points to at least one of a user device or the first vehicle.

14. A vehicle charging management method comprising:
determining, by a processor, an optimal vehicle charging time duration and an optimal vehicle discharging time duration for a first vehicle at a first location based on user itinerary information associated with a user, a current state of charge (SoC) level associated with the first vehicle and information associated with expected vehicle charging parameters at different times of a day, wherein the user itinerary information comprises an estimated time of user arrival at a first location from a user source location via the first vehicle; and
transmitting, by the processor, information associated with the optimal vehicle charging time duration and the optimal vehicle discharging time duration to least one of the first vehicle or a first charging station device associated with a first charging station located at the first location.

15. The vehicle charging management method of claim 14, wherein the expected vehicle charging parameters comprise at least one of an expected greenhouse gas emission rate and an expected per unit energy price.

16. The vehicle charging management method of claim 14, wherein the user itinerary information further comprises at least one of:
a distance between the user source location and the first location,
an estimated time of user departure from the first location to a second location via a second vehicle located at the first location,
an estimate time of user arrival at the second location via the second vehicle,
a distance between the second location and a user destination location,
an estimated time of user return to the second location from the user destination location, to travel to the first location via the second vehicle, and
an estimated time of user arrival at the first location from the second location via the second vehicle.

17. The vehicle charging management method of claim 16 further comprising:
estimating a first SoC level associated with the first vehicle at the estimated time of user arrival at the first location via the first vehicle, based on the user itinerary information;
determining a target SoC level associated with the first vehicle at the estimated time of user arrival at the first location from the second location via the second vehicle; and
determining the optimal vehicle charging time duration and the optimal vehicle discharging time duration based on the first SoC level and the target SoC level.

18. The vehicle charging management method of claim 17 further comprising:
receiving information associated with an expected first vehicle future usage; and
determining the target SoC level based on the information associated with the expected first vehicle future usage.

19. The vehicle charging management method of claim 14 further comprising:
determining that the first vehicle is connected to the first charging station;
determining real-time vehicle charging parameters responsive to determining that the first vehicle is connected to the first charging station;
determining that the real-time vehicle charging parameters are different from the expected vehicle charging parameters;
determining an updated optimal vehicle charging time duration and an updated optimal vehicle discharging time duration based on the real-time vehicle charging parameters, responsive to determining that the real-time vehicle charging parameters are different from the expected vehicle charging parameters; and
transmitting information associated with the updated optimal vehicle charging time duration and the updated optimal vehicle discharging time duration to least one of the first charging station device or the first vehicle.

20. A non-transitory computer-readable storage medium having instructions stored thereupon which, when executed by a processor, cause the processor to:
determine an optimal vehicle charging time duration and an optimal vehicle discharging time duration for a vehicle at a first location based on user itinerary information associated with a user, a current state of charge (SoC) level associated with the vehicle and information associated with expected vehicle charging parameters at different times of a day, wherein the user itinerary information comprises an estimated time of user arrival at the first location from a user source location via the vehicle; and
transmit information associated with the optimal vehicle charging time duration and the optimal vehicle discharging time duration to least one of the vehicle or a first charging station device associated with a first charging station located at the first location.
